(19) United States
(12) Patent Application Publication
(10) Pub. No.: US 2015/0263906 A1
(43) Pub. Date: Sep. 17, 2015

(54) METHOD AND APPARATUS FOR ENSURING APPLICATION AND NETWORK SERVICE PERFORMANCE IN AN AUTOMATED MANNER

(71) Applicant: Avni Networks Inc., Milpitas, CA (US)

(72) Inventors: Rohini Kumar KASTURI, Sunnyvale, CA (US); Satish GRANDHI, Santa Clara, CA (US); Baranidharan SEETHARAMAN, Sunnyvale, CA (US); Tushar Rajnikant JAGTAP, Sunnyvale, CA (US); Vijay Sundar RAJARAM, Fremont, CA (US)

(73) Assignee: Avni Networks Inc., Milpitas, CA (US)

(21) Appl. No.: 14/214,572

(22) Filed: Mar. 14, 2014

(51) Int. Cl. H04L 12/24

(52) U.S. Cl. CPC H04L 41/5019

(57) ABSTRACT

A method of managing a service level agreement (SLA) of a data center includes receiving information from a plurality of SLA agents, aggregating the received information and automatically scaling-up or scaling-down network service, network application, or network servers of the data center to meet the SLA.

### CROSS REFERENCE TO RELATED APPLICATIONS

This application is a continuation-in-part of U.S. patent application Ser. No. 14/214,472, filed on Mar. 14, 2014, by Kasturi et al., and entitled “PROCESSES FOR A HIGHLY SCALABLE, DISTRIBUTED, MULTI-CLOUD SERVICE DEPLOYMENT, ORCHESTRATION AND DELIVERY FABRIC”, which is a continuation-in-part of U.S. patent application Ser. No. 14/214,326, filed on Mar. 14, 2014, by Kasturi et al., and entitled “METHOD AND APPARATUS FOR A HIGHLY SCALABLE, MULTI-CLOUD SERVICE DEPLOYMENT, ORCHESTRATION AND DELIVERY”, which are incorporated herein by reference as though set forth in full.

### FIELD OF THE INVENTION

Various embodiments of the invention relate generally to a multi-cloud fabric and particularly to a Multi-cloud fabric with distributed application delivery.

### BACKGROUND

Data centers refer to facilities used to house computer systems and associated components, such as telecommunications (networking equipment) and storage systems. They generally include redundancy, such as redundant data communications connections and power supplies. These computer systems and associated components generally make up the Internet. A metaphor for the Internet is cloud.

A large number of computers connected through a real-time communication network such as the Internet generally form a cloud. Cloud computing refers to distributed computing over a network, and the ability to run a program or application on many connected computers of one or more clouds at the same time.

The cloud has become one of the, or perhaps even the, most desirable platform for storage and networking. A data center with one or more clouds may have real server hardware, and in fact served up by virtual hardware, simulated by software running on one or more real machines. Such virtual servers do not physically exist and can therefore be moved around and scaled up or down on the fly without affecting the end user, somewhat like a cloud becoming larger or smaller without being a physical object. Cloud bursting refers to a cloud becoming larger or smaller.

The cloud also focuses on maximizing the effectiveness of shared resources, resources referring to machines or hardware such as storage systems and/or networking equipment. Sometimes, these resources are referred to as instances. Cloud resources are usually not only shared by multiple users but are also dynamically reallocated per demand. This can work for allocating resources to users. For example, a cloud computer facility, or a data center, that serves Australian users during Australian business hours with a specific application (e.g., email) may reallocate the same resources to serve North American users during North America's business hours with a different application (e.g., a web server). With cloud computing, multiple users can access a single server to retrieve and update their data without purchasing licenses for different applications.

Cloud computing allows companies to avoid upfront infrastructure costs, and focus on projects that differentiate their businesses instead of infrastructure. It further allows enterprises to get their applications up and running faster, with improved manageability and less maintenance, and enables information technology (IT) to more rapidly adjust resources to meet fluctuating and unpredictable business demands.

Fabric computing or unified computing involves the creation of a computing fabric consisting of interconnected nodes that look like a ‘weave’ or a ‘fabric’ when viewed collectively from a distance. Usually this refers to a consolidated high-performance computing system consisting of loosely coupled storage, networking and parallel processing functions linked by high bandwidth interconnects.

The fundamental components of fabrics are “nodes” (processor(s), memory, and/or peripherals) and “links” (functional connection between nodes). Manufacturers of fabrics include IBM and Brocade. The latter are examples of fabrics made of hardware. Fabrics are also made of software or a combination of hardware and software.

A data center employed with a cloud currently suffers from latency, crashes due to underestimated usage, inefficiently uses of storage and networking systems of the cloud, and perhaps most importantly of all, manually deploys applications. Application deployment services are performed, in large part, manually with elaborate infrastructure, numerous teams of professionals, and potential failures due to unexpected bottlenecks. Some of the foregoing translates to high costs. Lack of automation results in delays in launching business applications. It is estimated that application delivery services currently consumes approximately thirty percent of the time required for deployment operations. Additionally, scalability of applications across multiple clouds is nearly nonexistent.

There is therefore a need for a method and apparatus to decrease bottleneck, latency, infrastructure, and costs while increasing efficiency and scalability of a data center.

### SUMMARY

Briefly, a method of the invention includes managing a service level agreement (SLA) of a data center includes receiving information from a plurality of SLA agents, aggregating the received information and automatically scaling-up or scaling-down network service, network application, or network servers of the data center to meet the SLA.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a data center 100, in accordance with an embodiment of the invention.

FIG. 2 shows further details of relevant portions of the data center 100 and in particular, the fabric 106 of FIG. 1.

FIG. 3 shows conceptually various features of the data center 300, in accordance with an embodiment of the invention.

FIG. 4 shows, in conceptual form, relevant portion of a multi-cloud data center 400, in accordance with another embodiment of the invention.

FIGS. 4a-c show exemplary data centers configured using embodiments and methods of the invention.

FIG. 5 shows relevant portions of the data center 100, in accordance with an embodiment of the invention.

FIG. 6 shows a high level block diagram of a distributed multi-cloud resident elastic application 600, in accordance with an embodiment of the invention.

FIG. 7 shows a cloud 702 in accordance with an exemplary embodiment of the invention.

FIGS. 8-11 show flow charts of relevant steps performed by the SLA engine of the data center 100 in carrying out certain functions, in accordance with various methods of the invention.

FIG. 12 shows a high-level block diagram of a data center using multiple tiers, in accordance with an embodiment of the invention.

### DETAILED DESCRIPTION OF EMBODIMENTS

The following description describes a multi-cloud fabric. The multi-cloud fabric has a controller and spans homogeneously and seamlessly across the same or different types of clouds, as discussed below.

Particular embodiments and methods of the invention disclose a virtual multi-cloud fabric. Still other embodiments and methods disclose automation of application delivery by use of the multi-cloud fabric.

In other embodiments, a data center includes a plug-in, application layer, multi-cloud fabric, network, and one or more the same or different types of clouds.

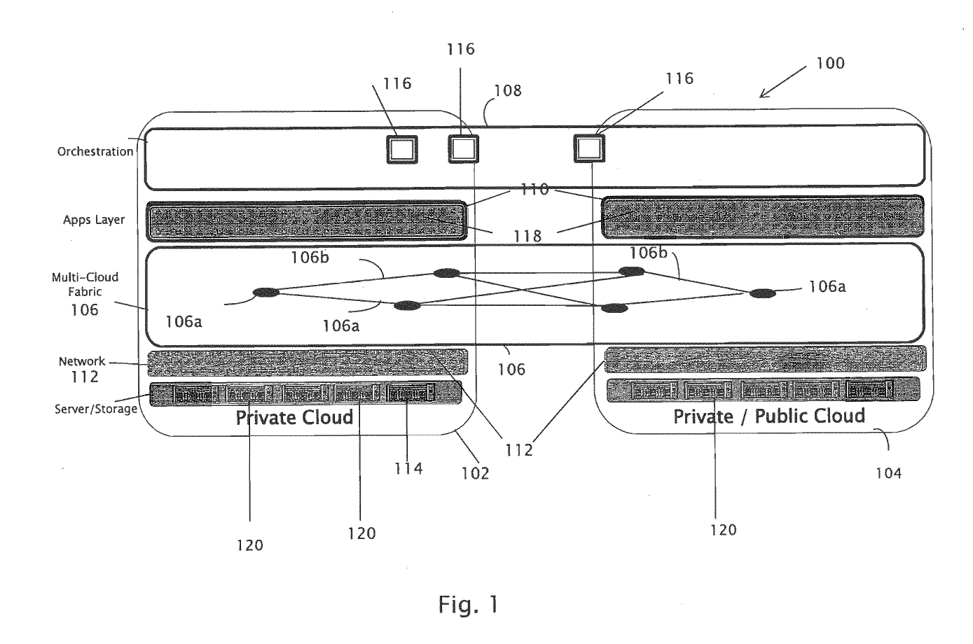

Referring now to FIG. 1, a data center 100 is shown, in accordance with an embodiment of the invention. The data center 100 is shown to include a private cloud 102 and a hybrid cloud 104. A hybrid cloud is a combination public and private cloud. The data center 100 is further shown to include a plug-in unit 108 and an multi-cloud fabric 106 spanning across the clouds 102 and 104. Each of the clouds 102 and 104 are shown to include a respective application layer 110, a network 112, and resources 114.

The network 112 includes switches and the like and the resources 114 are router, servers, and other networking and/or storage equipment.

The application layers 110 are each shown to include applications 118 and the resources 114 further include machines, such as servers, storage systems, switches, servers, routers, or any combination thereof.

The plug-in unit 108 is shown to include various plug-ins. As an example, in the embodiment of FIG. 1, the plug-in unit 108 is shown to include several distinct plug-ins 116, such as one made by Opensource, another made by Microsoft, Inc., and yet another made by VMware, Inc. Each of the foregoing plug-ins typically have different formats. The plug-in unit 108 converts all of the various formats of the applications into one or more native-format application for use by the multi-cloud fabric 106. The native-format application(s) is passed through the application layer 110 to the multi-cloud fabric 106.

The multi-cloud fabric 106 is shown to include various nodes 106a and links 106b connected together in a weave-like fashion.

In some embodiments of the invention, the plug-in unit 108 and the multi-cloud fabric 106 do not span across clouds and the data center 100 includes a single cloud. In embodiments with the plug-in unit 108 and multi-cloud fabric 106 spanning across clouds, such as that of FIG. 1, resources of the two clouds 102 and 104 are treated as resources of a single unit. For example, an application may be distributed across the resources of both clouds 102 and 104 homogeneously thereby making the clouds seamless. This allows use of analytics, searches, monitoring, reporting, displaying and otherwise data crunching thereby optimizing services and use of resources of clouds 102 and 104 collectively.

While two clouds are shown in the embodiment of FIG. 1, it is understood that any number of clouds, including one cloud, may be employed. Furthermore, any combination of private, public and hybrid clouds may be employed. Alternatively, one or more of the same type of cloud may be employed.

In an embodiment of the invention, the multi-cloud fabric 106 is a Layer (L) 4-7 fabric. Those skilled in the art appreciate data centers with various layers of networking. As earlier noted, Multi-cloud fabric 106 is made of nodes 106a and connections (or “links”) 106b. In an embodiment of the invention, the nodes 106a are devices, such as but not limited to L4-L7 devices. In some embodiments, the multi-cloud fabric 106 is implemented in software and in other embodiments, it is made with hardware and in still others, it is made with hardware and software.

The multi-cloud fabric 106 sends the application to the resources 114 through the networks 112.

In an SLA engine, as will be discussed relative to a subsequent figure, data is acted upon in real-time. Further, the data center 100 dynamically and automatically delivers applications, virtually or in physical reality, in a single or multi-cloud of either the same or different types of clouds.

The data center 100, in accordance with some embodiments and methods of the invention, serves as a service (Software as a Service (SAAS) model, a software package through existing cloud management platforms, or a physical appliance for high scale requirements. Further, licensing can be throughput or flow-based and can be enabled with network services only, network services with SLA and elasticity engine (as will be further evident below), network service enablement engine, and/or multi-cloud engine.

As will be further discussed below, the data center 100 may be driven by representational state transfer (REST) application programming interface (API).

The data center 100, with the use of the multi-cloud fabric 106, eliminates the need for an expensive infrastructure, manual and static configuration of resources, limitation of a single cloud, and delays in configuring the resources, among other advantages. Rather than a team of professionals configuring the resources for delivery of applications over months of time, the data center 100 automatically and dynamically does the same, in real-time. Additionally, more features and capabilities are realized with the data center 100 over that of prior art. For example, due to multi-cloud and virtual delivery capabilities, cloud bursting to existing clouds is possible and utilized only when required to save resources and therefore expenses.

Moreover, the data center 100 effectively has a feedback loop in the sense that results from monitoring traffic, performance, usage, time, resource limitations and the like, i.e. the configuration of the resources can be dynamically altered based on the monitored information. A log of information pertaining to configuration, resources, the environment, and the like allow the data center 100 to provide a user with pertinent information to enable the user to adjust and substantially optimize its usage of resources and clouds. Similarly, the data center 100 itself can optimize resources based on the foregoing information.

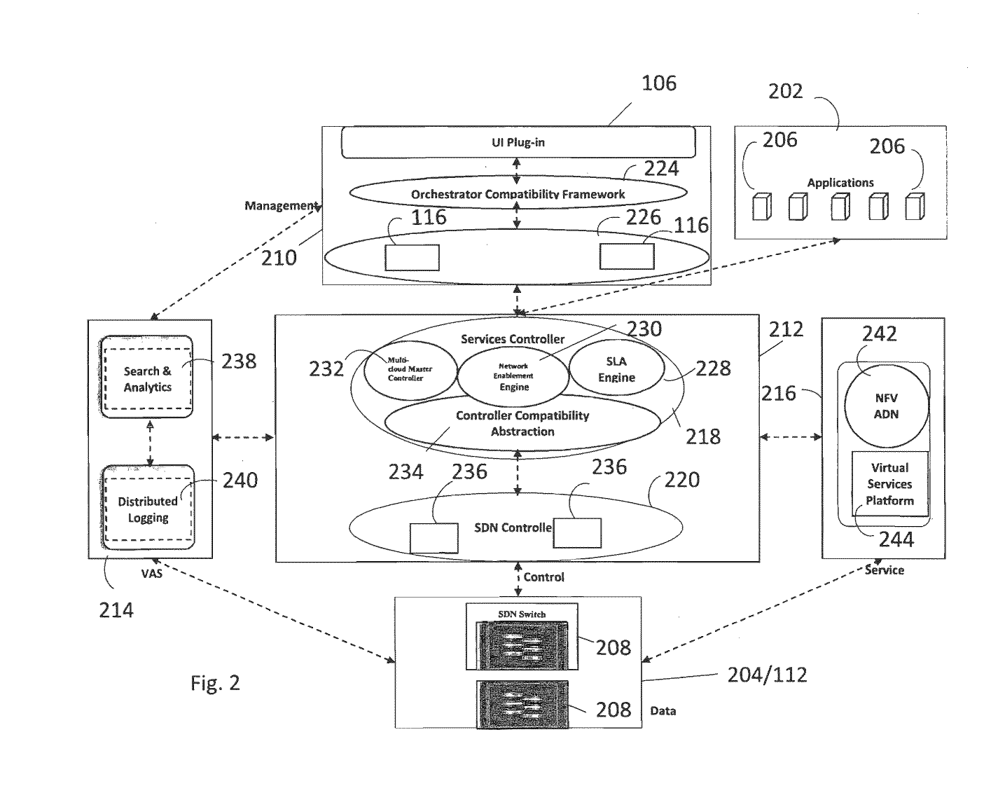

FIG. 2 shows further details of relevant portions of the data center 100 and in particular, the fabric 106 of FIG. 1. The fabric 106 is shown to be in communication with a applications unit 202 and a network 204, which is shown to include a number of Software Defined Networking (SDN)-enabled controllers and switches 208. The network 204 is analogous to the network 112 of FIG. 1.

The applications unit 202 is shown to include a number of applications 206, for instance, for an enterprise. These applications are analyzed, monitored, searched, and otherwise crunched just like the applications from the plug-ins of the fabric 106 for ultimate delivery to resources through the network 204.

The data center 100 is shown to include five units (or planes), the management unit 210, the value-added services (VAS) unit 214, the controller unit 212, the service unit 216 and the data unit (or network) 204. Accordingly and advantageously, control, data, VAS, network services and management are provided separately. Each of the planes is an agent and the data from each of the agents is crunched by the controller 212 and the VAS unit 214.

The fabric 106 is shown to include the management unit 210, the VAS unit 214, the controller unit 212 and the service unit 216. The management unit 210 is shown to include a user interface (UI) plug-in 222, an orchestrator compatibility framework 224, and applications 226. The management unit 210 is analogous to the plug-in 108. The UI plug-in 222 and the applications 226 receive applications of various formats and the framework 224 translates the various formatted application into native-format applications. Examples of plug-ins 116, located in the applications 226, are VMware ICenter, by VMware, Inc. and System Center by Microsoft, Inc. While two plug-ins are shown in FIG. 2, it is understood that any number may be employed.

The controller unit (also referred to herein as “multi-cloud master controller”) 212 serves as the master or brain of the data center 100 in that it controls the flow of data throughout the data center and timing of various events, to name a couple of many other functions it performs as the mastermind of the data center. It is shown to include a services controller 218 and a SDN controller 220. The services controller 218 is shown to include a multi-cloud master controller 232, an application delivery services stitching engine or network enablement engine 230, a SLA engine 228, and a controller compatibility abstraction 234.

Typically, one of the clouds of a multi-cloud network is the master of the clouds and includes a multi-cloud master controller that talks to local cloud controllers (or managers) to help configure the topology among other functions. The master cloud includes the SLA engine 228 whereas other clouds need not to but all clouds include a SLA agent and a SLA aggregator with the former typically being a part of the virtual services platform 244 and the latter being a part of the search and analytics 238.

The controller compatibility abstraction 234 provides abstraction to enable handling of different types of controllers (SDN controllers) in a uniform manner to offload traffic in the switches and routers of the network 204. This increases response time and performance as well as allowing more efficient use of the network.

The network enablement engine 230 performs stitching where an application or network services (such as configuring load balance) is automatically enabled. This eliminates the need for the user to work on meeting, for instance, a load balance policy. Moreover, it allows scaling out automatically when violating a policy.

The flex cloud engine 232 handles multi-cloud configurations such as determining, for instance, which cloud is less costly, or whether an application must go onto more than one cloud based on a particular policy, or the number and type of cloud that is best suited for a particular scenario.

The SLA engine 228 monitors various parameters in real-time and decides if policies are met. Exemplary parameters include different types of SLAs and application parameters. Examples of different types of SLAs include network SLAs and application SLAs. The SLA engine 228, besides monitoring allows for acting on the data, such as service plane (L4-L7), application, network data and the like, in real-time.

The practice of service assurance enables Data Centers (DCs) and (or) Cloud Service Providers (CSPs) to identify faults in the network and resolve these issues in a timely manner so as to minimize service downtime. The practice also includes policies and processes to proactively pinpoint, diagnose and resolve service quality degradations or device malfunctions before subscribers (users) are impacted.

Service assurance encompasses the following:
Fault and event management
   Performance management
   Probe monitoring
   Quality of service (QoS) management
   Network and service testing
   Network traffic management
   Customer experience management
   Real-time SLA monitoring and assurance
   Service and Application availability
   Trouble ticket management

The structures shown included in the controller unit 212 are implemented using one or more processors executing software (or code) and in this sense, the controller unit 212 may be a processor. Alternatively, any other structures in FIG. 2 may be implemented as one or more processors executing software. In other embodiments, the controller unit 212 and perhaps some or all of the remaining structures of FIG. 2 may be implemented in hardware or a combination of hardware and software.

VAS unit 214 uses its search and analytics unit 238 to search analytics based on distributed large data engine and crunches data and displays analytics. The search and analytics unit 238 can filter all of the logs the distributed logging unit 240 of the VAS unit 214 logs, based on the customer's (user's) desires. Examples of analytics include events and logs. The VAS unit 214 also determines configurations such as who needs SLA, who is violating SLA, and the like.

The SDN controller 220, which includes software defined network programmability, such as those made by Floodligh, Open Daylight, PDX, and other manufacturers, receives all the data from the network 204 and allows for programmability of a network switch/router.

The service plane 216 is shown to include an API based, Network Function Virtualization (NFV), Application Delivery Network (ADN) 242 and on a Distributed virtual services platform 244. The service plane 216 activates the right components based on rules. It includes ADC, web-application firewall, DPI, VPN, DNS and other L4-L7 services and configures based on policy (it is completely distributed). It can also include any application or L4-L7 network services.

The distributed virtual services platform contains an Application Delivery Controller (ADC), Web Application Firewall (Firewall), L2-L3 Zonal Firewall (ZFW), Virtual Private Network (VPN), Deep Packet Inspection (DPI), and various other services that can be enabled as a single-pass architecture. The service plane contains a Configuration agent, Stats/Analytics reporting agent, Zero-copy driver to send and receive packets in a fast manner, Memory mapping engine that maps memory via TLB to any virtualized platform/hypervisor, SSL offload engine, etc.

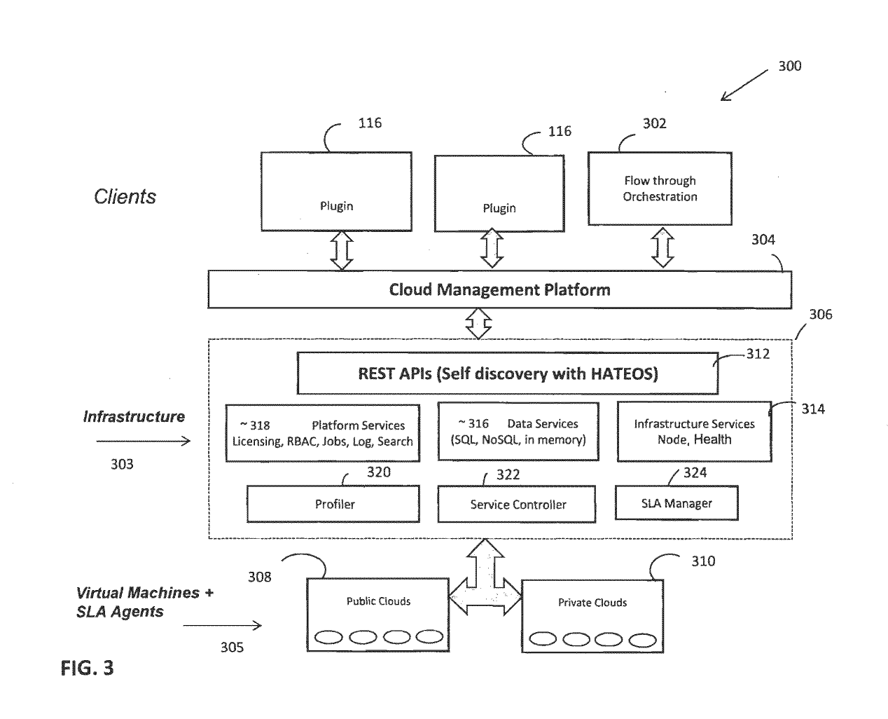

FIG. 3 shows conceptually various features of the data center 300, in accordance with an embodiment of the invention. The data center 300 is analogous to the data center 100 except some of the features/structures of the data center 300 are in addition to those shown in the data center 100. The data center 300 is shown to include plug-ins 116, flow-through orchestration 302, cloud management platform 304, controller 306, and public and private clouds 308 and 310, respectively.

The controller 306 is analogous to the controller 212 of FIG. 2. In FIG. 3, the controller 306 is shown to include a REST APIs-based invocations for self-discovery, platform services 318, data services 316, infrastructure services 314, profiler 320, service controller 322, and SLA manager 324.

The flow-through orchestration 302 is analogous to the framework 224 of FIG. 2. Plug-ins 116 and orchestration 302 provide applications to the cloud management platform 304, which converts the formats of the applications to native format. The native-formatted applications are processed by the controller 306, which is analogous to the controller 212 of FIG. 2. The RESI APIs 312 drive the controller 306. The platform services 318 is for services such as licensing, Role Based Access and Control (RBAC), jobs, log, and search. The data services 316 is to store data of various components, services, applications, databases such as Search and Query Language (SQL), NoSQL, data in memory. The infrastructure services 314 is for services such as node and health.

The profiler 320 is a test engine. Service controller 322 is analogous to the controller 220 and SLA manager 324 is analogous to the SLA engine 228 of FIG. 2. During testing by the profiler 320, simulated traffic is run through the data center 300 to test for proper operability as well as adjustment of parameters such as response time, resource and cloud requirements, and processing usage.

In the exemplary embodiment of FIG. 3, the controller 306 interacts with public clouds 308 and private clouds 310. Each of the clouds 308 and 310 include multiple clouds and communicate not only with the controller 306 but also with each other. Benefits of the clouds communicating with one another is optimization of traffic path, dynamic traffic steering, and/or reduction of costs, among perhaps others.

The plug-ins 116 and the flow-through orchestration 302 are the clients 310 of the data center 300, the controller 306 is the infrastructure of the data center 300, and the clouds 308 and 310 are the virtual machines and SLA agents 305 of the data center 300.

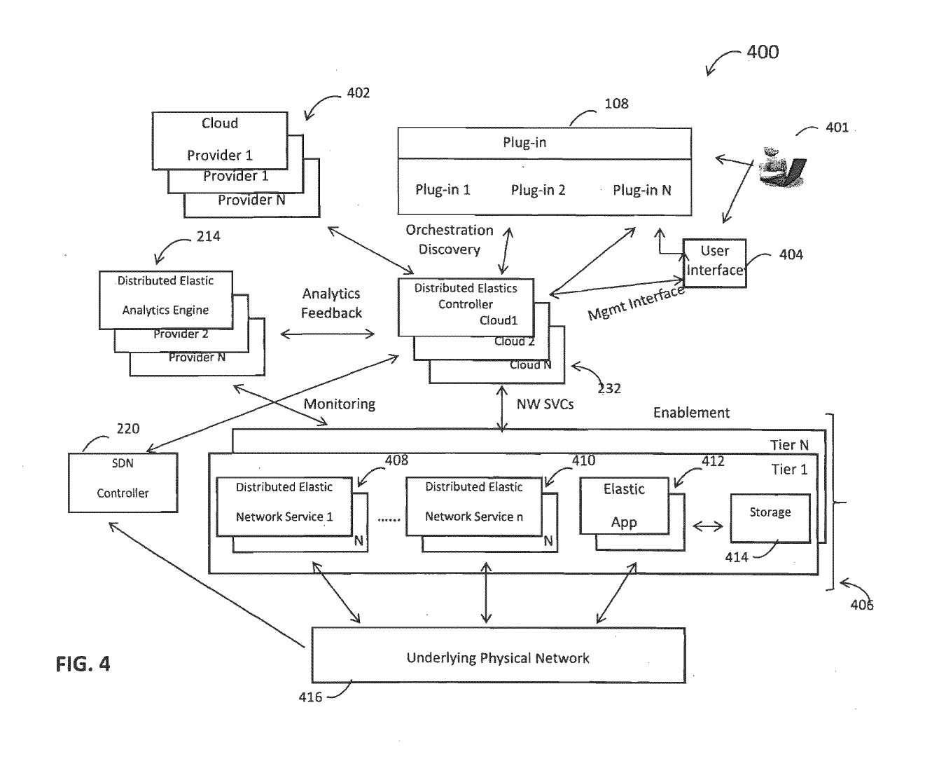

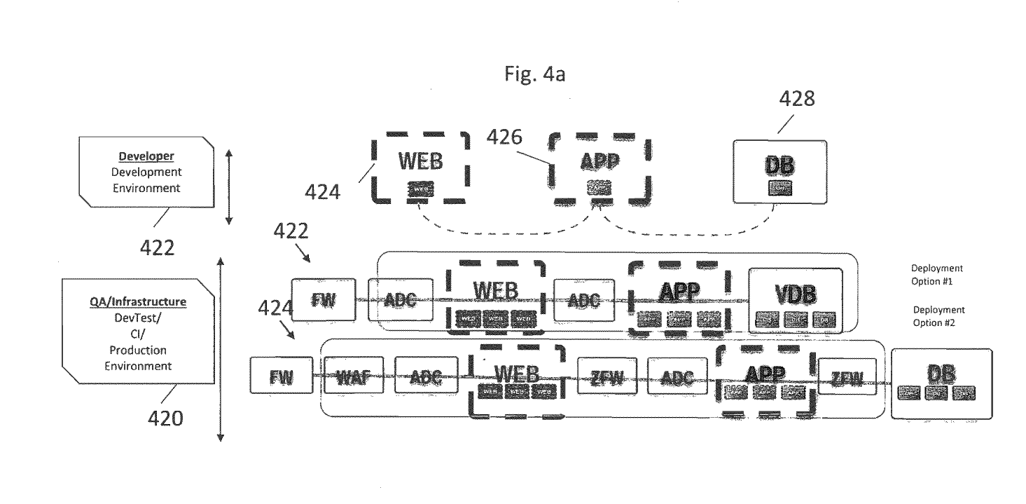

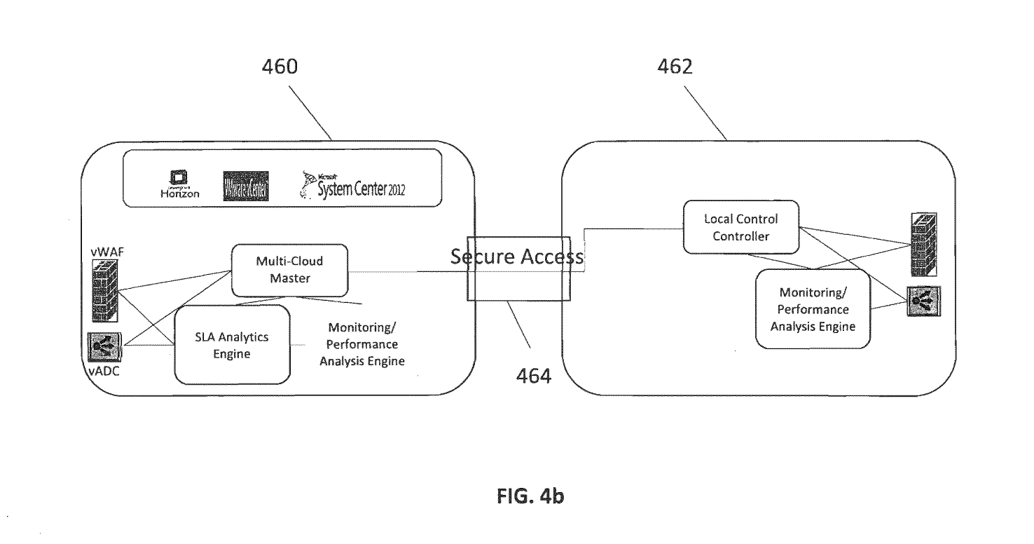

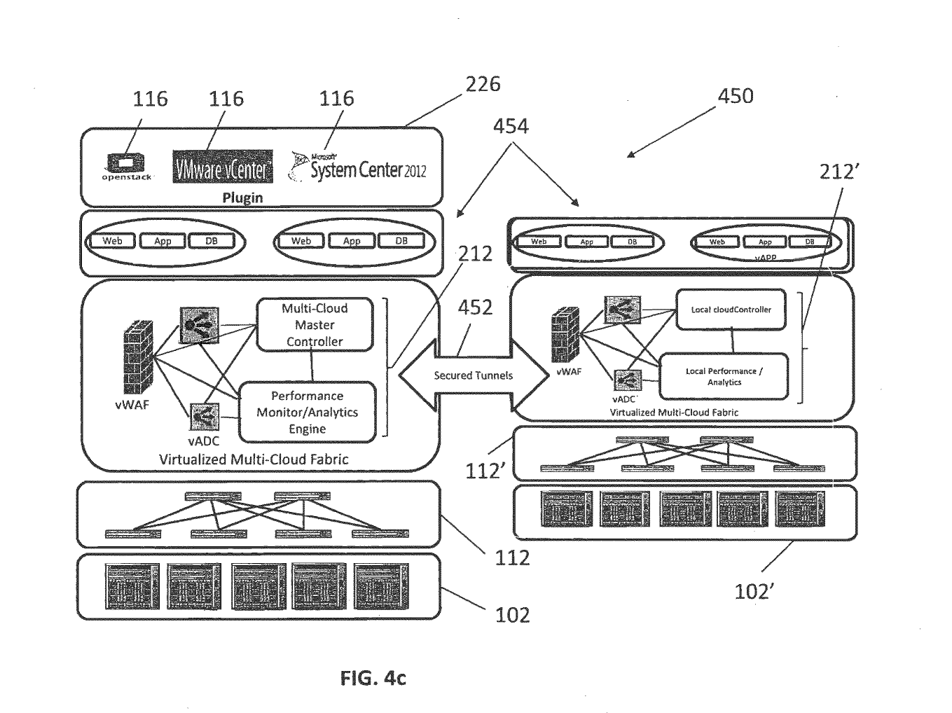

FIG. 4 shows, in conceptual form, relevant portion of a multi-cloud data center 400, in accordance with another embodiment of the invention. A client (or user) 401 is shown to use the data center 400, which is shown to include plug-in units 108, cloud providers 1-N 402, distributed elastic analytics engine (or “VAS unit”) 214, distributed elastic controller (of clouds 1-N) (also known herein as “flex cloud engine” or “multi-cloud master controller”) 232, tiers 1-N, underlying physical NW 416, such as Servers, Storage, Network elements, etc. and SDN controller 220.

Each of the tiers 1-N is shown to include distributed elastic 1-N, 408-410, respectively, elastic applications 412, and storage 414. The distributed elastic 1-N 408-410 and elastic applications 412 communicate bidirectional with the underlying physical NW 416 and the latter unilaterally provides information to the SDN controller 220. A part of each of the tiers 1-N are included in the service plane 216 of FIG. 2.

The cloud providers 402 are providers of the clouds shown and/or discussed herein. The distributed elastic controllers 1-N each service a cloud from the cloud providers 402, as discussed previously except that in FIG. 4, there are N number of clouds, “N” being an integer value.

As previously discussed, the distributed elastic analytics engine 214 includes multiple VAS units, one for each of the clouds, and the analytics are provided to the controller 232 for various reasons, one of which is the feedback feature discussed earlier. The controllers 232 also provide information to the engine 214, as discussed above.

The distributed elastic services 1-N are analogous to the services 318, 316, and 314 of FIG. 3 except that in FIG. 4, the services are shown to be distributed, as are the controllers 232 and the distributed elastic analytics engine 214. Such distribution allows flexibility in the use of resource allocation therefore minimizing costs to the user among other advantages.

The underlying physical NW 416 is analogous to the resources 114 of FIG. 1 and that of other figures herein. The underlying network and resources include servers for running any applications, storage, network elements such as routers, switches, etc. The storage 414 is also a part of the resources.

The tiers 406 are deployed across multiple clouds and are enablement. Enablement refers to evaluation of applications for L4 through L7. An example of enablement is stitching.

In summary, the data center of an embodiment of the invention, is multi-cloud and capable of application deployment, application orchestration, and application delivery.

In operation, the user (or “client”) 401 interacts with the UI 404 and through the UI 404, with the plug-in unit 108. Alternatively, the user 401 interacts directly with the plug-in unit 108. The plug-in unit 108 receives applications from the user with perhaps certain specifications. Orchestration and discover take place between the plug-in unit 108, the controllers 232 and between the providers 402 and the controllers 232. A management interface (also known herein as “management unit” 210) manages the interactions between the controllers 232 and the plug-in unit 108.

The distributed elastic analytics engine 214 and the tiers 406 perform monitoring of various applications, application delivery services and network elements and the controllers 232 effectuate service change.

In accordance with various embodiments and methods of the invention, some of which are shown and discussed herein, an Multi-cloud fabric is disclosed. The Multi-cloud fabric includes an application management unit responsive to one or more applications from an application layer. The Multi-cloud fabric further includes a controller in communication with resources of a cloud, the controller is responsive to the received application and includes a processor operable to analyze the received application relative to the resources to cause delivery of the one or more applications to the resources dynamically and automatically.

The multi-cloud fabric, in some embodiments of the invention, is virtual. In some embodiments of the invention, the multi-cloud fabric is operable to deploy the one or more native-format applications automatically and/or dynamically. In still other embodiments of the invention, the controller is in communication with resources of more than one cloud.

The processor of the multi-cloud fabric is operable to analyze applications relative to resources of more than one cloud.

In an embodiment of the invention, the Value Added Services (VAS) unit is in communication with the controller and the application management unit and the VAS unit is operable to provide analytics to the controller. The VAS unit is operable to perform a search of data provided by the controller and filters the searched data based on the user's specifications (or desire).

In an embodiment of the invention, the Multi-cloud fabric includes a service unit that is in communication with the controller and operative to configure data of a network based on rules from the user or otherwise.

In some embodiments, the controller includes a cloud engine that assesses multiple clouds relative to an application and resources. In an embodiment of the invention, the controller includes a network enablement engine.

In some embodiments of the invention, the application deployment fabric includes a plug-in unit responsive to applications with different format applications and operable to convert the different format applications to a native-format application. The application deployment fabric can report configuration and analytics related to the resources to the user. The application deployment fabric can have multiple clouds including one or more private clouds, one or more public clouds, or one or more hybrid clouds. A hybrid cloud is private and public.

The application deployment fabric configures the resources and monitors traffic of the resources, in real-time, and based at least on the monitored traffic, re-configure the resources, in real-time.

In an embodiment of the invention, the Multi-cloud fabric can stitch end-to-end, i.e. an application to the cloud, automatically.

In an embodiment of the invention, the SLA engine of the Multi-cloud fabric sets the parameters of different types of SLA in real-time.

In some embodiments, the Multi-cloud fabric automatically scales in or scales out the resources. For example, upon an underestimation of resources or unforeseen circumstances requiring addition resources, such as during a super bowl game with subscribers exceeding an estimated and planned for number, the resources are scaled out and perhaps use existing resources, such as those offered by Amazon, Inc. Similarly, resources can be scaled down.

The following are some, but not all, various alternative embodiments. The Multi-cloud fabric is operable to stitch across the cloud and at least one more cloud and to stitch network services, in real-time.

The multi-cloud fabric is operable to burst across clouds other than the cloud and access existing resources.

The controller of the Multi-cloud fabric receives test traffic and configures resources based on the test traffic.

Upon violation of a policy, the Multi-cloud fabric automatically scales the resources.

The SLA engine of the controller monitors parameters of different types of SLA in real-time.

The SLA includes application SLA and networking SLA, among other types of SLA contemplated by those skilled in the art.

The Multi-cloud fabric may be distributed and it may be capable of receiving more than one application with different formats and to generate native-format applications from the more than one application.

The resources may include storage systems, servers, routers, switches, or any combination thereof.

The analytics of the Multi-cloud fabric include but not limited to traffic, response time, connections/sec, throughput, network characteristics, disk I/O or any combination thereof.

In accordance with various alternative methods, of delivering an application by the multi-cloud fabric, the multi-cloud fabric receives at least one application, determines resources of one or more clouds, and automatically and dynamically delivers the at least one application to the one or more clouds based on the determined resources. Analytics related to the resources are displayed on a dashboard or otherwise and the analytics help cause the Multi-cloud fabric to substantially optimally deliver the at least one application.

FIGS. 4a-c show exemplary data centers configured using embodiments and methods of the invention. FIG. 4a shows the example of a work flow of a 3-tier application development and deployment. At 422 is shown a developer's development environment including a web tier 424, an application tier 426 and a database 428, each used by a user for different purposes typically and perhaps requiring its own security measure. For example, a company like Yahoo, Inc. may use the web tier 424 for its web and the application tier 426 for its applications and the database 428 for its sensitive data. Accordingly, the database 428 may be a part of a private rather than a public cloud. The tiers 424 and 426 and database 420 are all linked together.

At 420, development testing and production environment is shown. At 422, an optional deployment is shown with a firewall (FW), ADC, a web tier (such as the tier 404), another ADC, an application tier (such as the tier 406), and a virtual database (same as the database 428). ADC is essentially a load balancer. This deployment may not be optimal and actually far from it because it is an initial pass and without the use of some of the optimizations done by various methods and embodiments of the invention. The instances of this deployment are stitched together (or orchestrated).

At 424, another optional deployment is shown with perhaps greater optimization. A FW is followed by a web-application FW (WFW), which is followed by an ADC and so on. Accordingly, the instances shown at 424 are stitched together.

Accordingly, consistent development/production environments are realized. Automated discovery, automatic stitching, test and verify, real-time SLA, automatic scaling up/down capabilities of the various methods and embodiments of the invention may be employed for the three-tier (web, application, and database) application development and deployment of FIG. 4a. Further, deployment can be done in minutes due to automation and other features. Deployment can be to a private cloud, public cloud, or a hybrid cloud or multi-clouds.

FIG. 4b shows an exemplary multi-cloud having a public, private, or hybrid cloud 460 and another public or private or hybrid cloud 464 communication through a secure access 464. The cloud 460 is shown to include the master controller whereas the cloud 462 is the slave or local cloud controller. Accordingly, the SLA engine resides in the cloud 460.

FIG. 4c shows a virtualized multi-cloud fabric spanning across multiple clouds with a single point of control and management.

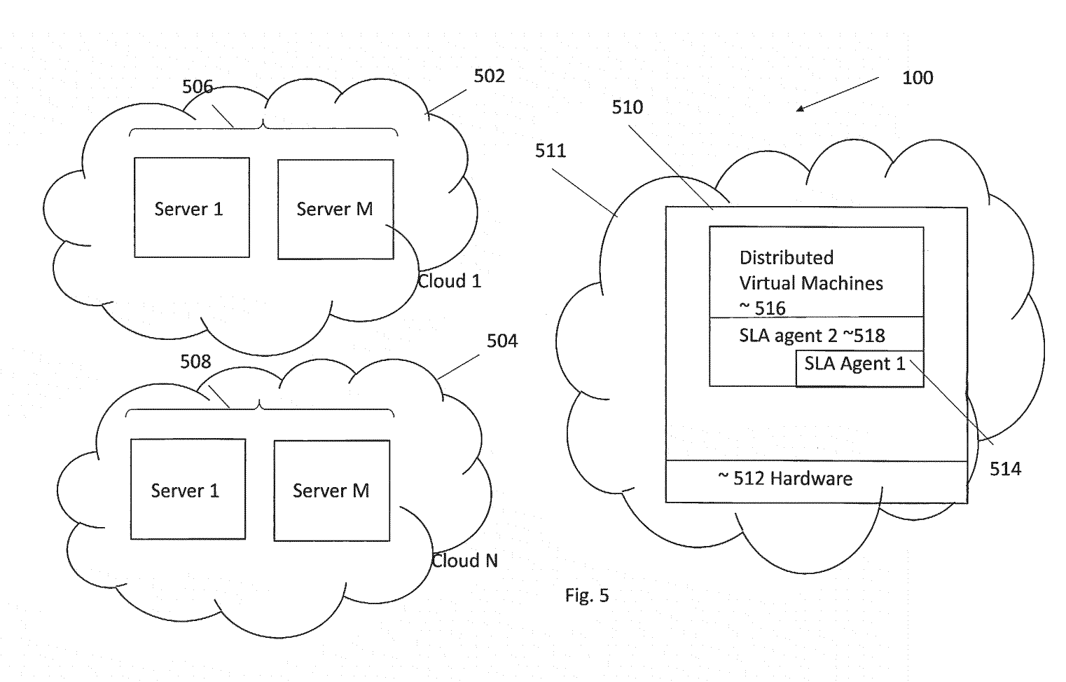

FIG. 5 shows relevant portions of the data center 100, in accordance with an embodiment of the invention. A number of clouds 502-504, namely ‘N’ number of clouds, are shown in the embodiment of FIG. 5. ‘N’ is an integer value. The clouds 520-504 are each analogous to the cloud 102 or 104. Each of the clouds 502-504 is shown to include an M number of servers. For example, the cloud 502 is shown to include the servers 506 and the cloud 504 is shown to include the servers 508.

The cloud 511, also a part of the data center 100, is shown to include hardware 512, in addition to SLA agents 514 and 518, as well as a virtual VM 516. Each cloud of a multi-cloud network typically includes its own SLA agent and SLA aggregator but only one cloud has a SLA engine, which is the master.

In some embodiments, the SLA engine is machine-learning SLA Engine that uses some of the machine-learning techniques to perform its functionality. More specifically, it learns about the characteristics of an application and applies them to similar applications.

The host running x86 hardware (processor) 510 is shown to include hardware 512, distributed VMs 516, and SLA agent 514 and SLA agent 518, which is shown to include SLA agent 514. FIG. 5 indicates that there can be one or more clouds. Each cloud can contain many host machines (x86 or other) that can run multiple VMs. Each VM has an SLA agent running on it to collect various type of SLA metrics. All the SLA agents send the data to distributed elastic analytics engine.

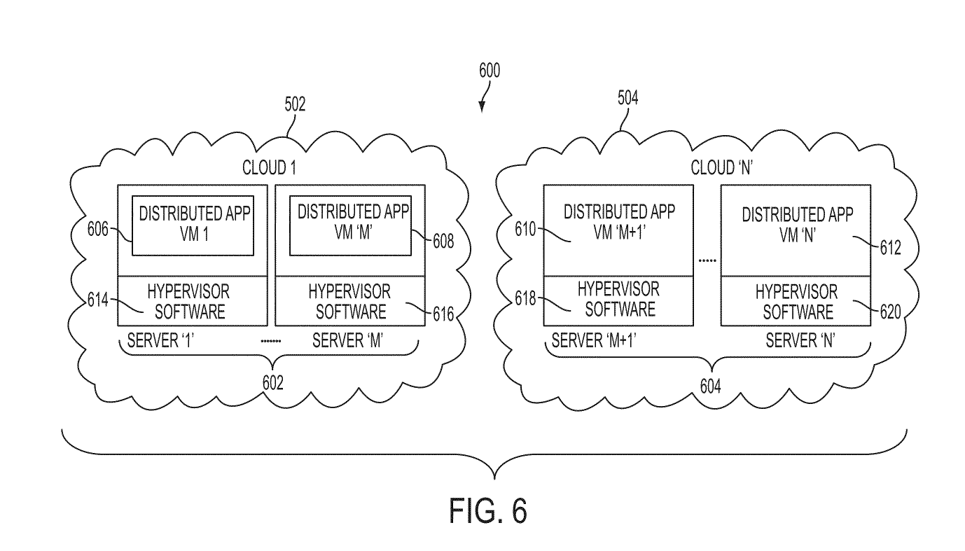

FIG. 6 shows a high level block diagram of a distributed multi-cloud resident elastic application 600, in accordance with an embodiment of the invention. It is noted as one of ordinary skill would contemplate that this is merely an exemplary application of many others too numerous to list. Distributed Multi-Cloud Resident Elastic Application refers to an application that can reside on one or more VMs across multiple hosts and across multiple clouds.

The clouds 502 and 504 of FIG. 5 are shown in greater detail in FIG. 6. Each of the clouds, as in FIG. 5, is shown to include a number of servers in FIG. 6. For instance, cloud 502 is shown to include servers 1 through m, or servers 602, and cloud 504 is shown to include servers m+1 to n, or servers 604, with ‘n’ and ‘m’ each being an integer value. The servers of clouds 502 and 504 hold distributed applications. For example, a distributed application, VM 1 606 is a part of the same application as that which the distributed application VM m 608 (of cloud 502) and the distributed application VM m+1 610 (of cloud 504) are. Accordingly, this application is shown not only distributed within the cloud 502 but also distributed across clouds 502 and 504. The cloud 504 is shown to also include the distributed application VM n 612. The distributed application may be a network service or any software application. It is understood that in FIG. 6, two clouds are shown, any number of clouds may be employed with each cloud being a private cloud, a public cloud, or a hybrid cloud.

Each of the servers of the servers 602 of cloud 502 is shown to further include a hypervisor software. For example, the server 1 of the servers 602 is shown to include hypervisor software 614, server m of cloud 502 is shown to include hypervisor software 616, server m+1 of the servers 604 of cloud 504 is shown to include the hypervisor software 618 and the server n of the servers 604 of cloud 504 is shown to include the hypervisor software 620. Hypervisor manages various VMs on a host machine.

FIG. 7 shows a cloud 702 in accordance with an exemplary embodiment of the invention. The cloud 702, which is analogous to any of the clouds shown and discussed herein, is shown to include a SLA and elasticity engine 704 and devices 1 through n, or device 706 through device 708.

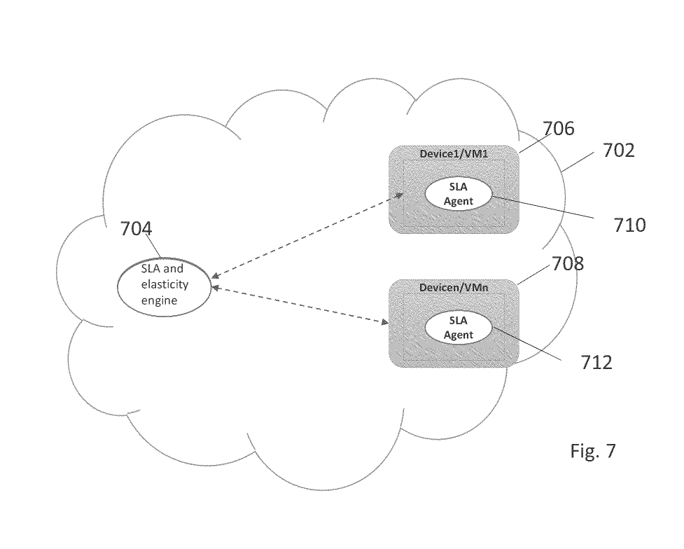

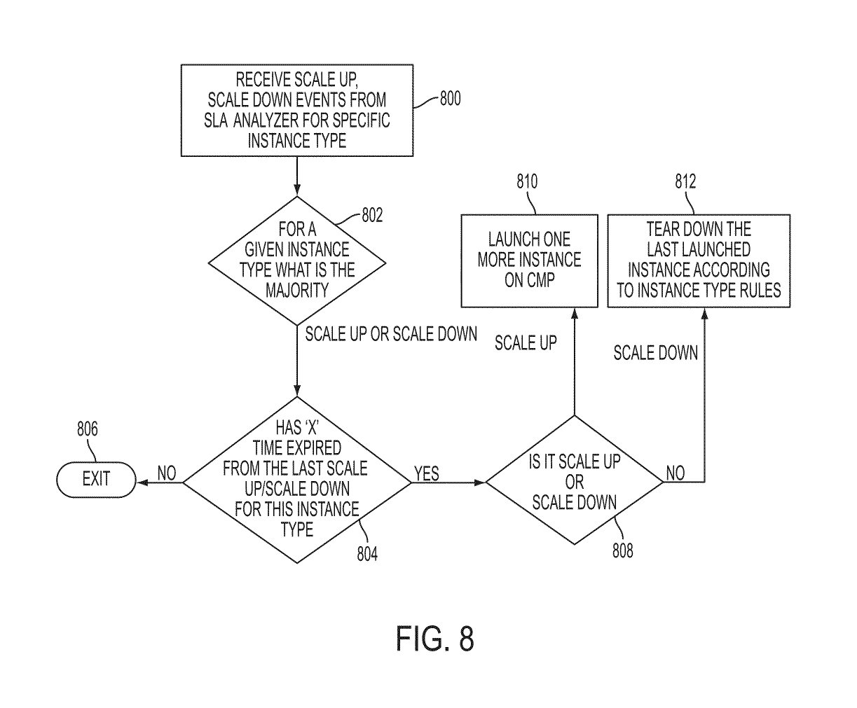

FIGS. 8-11 show flow charts of relevant steps performed by the SLA engine of the data center 100 in carrying out certain functions, in accordance with various methods of the invention. In FIG. 8, steps are shown for correlating SLA events. At step 800, the Distributed Elastic Analytics Correlator receives scale up, scale down, events from SLA aggregator/analyzer of the Distributed Elastic Analytics Engine for a specific instance type. Next, at 802, a decision is made as to what the majority is for a given instance type and if it is scale-up or scale-down, the process continues to 804 where a determination is made as to whether or not the time from the last time a scale-up/scale-down was done for this particular instance type has expired or not. In other words, is there an incomplete scale-up/scale-down for this particular instance type. If there is, the process exits at 806 to wait for the on-going scale-up/scale-down to complete, otherwise, the process continues to 808. At 808, a determination is made as to whether this is a scale-up or scale-down process and upon a determination of the former, the process continues to step 810 and upon a determination of the latter, the process continues to step 812.

At step 810, one more instance is launched on CMP and at step 812, the last launched instance is torn down in accordance with the instance type rules. Examples of instance types are Application Delivery Controller (ADC), Web Application Firewall (WAF) and any Application Server or a service.

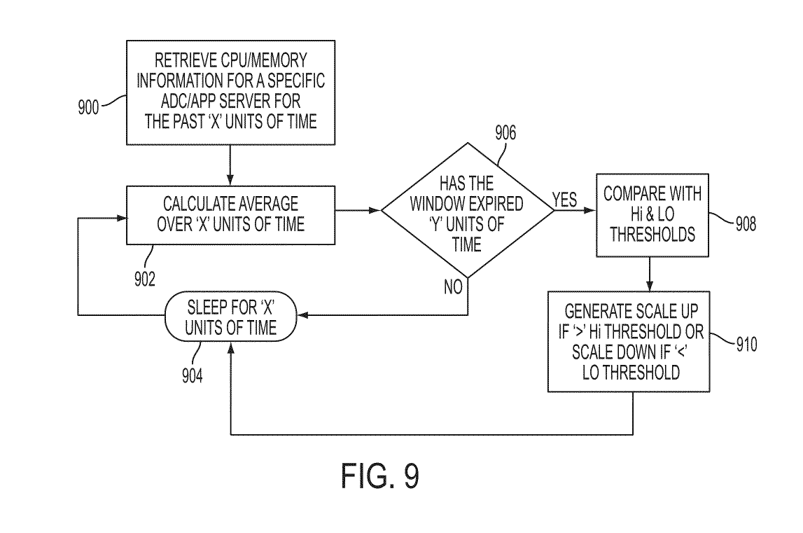

FIG. 9 shows a flow chart of the relevant steps for performing SLA analysis for the CPU/memory SLAs of the SLA engine. At step 900, CPU/memory information is retrieved from the time series statistics database of the SLA Engine, for a specific ADC/Application server or any service for the past ‘x’ units of time, ‘x’ being a number. The time series statistics database is populated periodically with statistics information collected by Avni agent running on various VMs. Next, at step 902, an average of the various SLA Metrics is calculated over the ‘x” units of time. Next, a determination is made as to whether or not, the window of ‘y’ units of time has expired. In other words, has ‘y’ amount of time passed and if not, the process continues to 904, otherwise, the process continues to step 908. At 904, the process waits (or goes to sleep) for an ‘x’ number of units of time and when ‘x’ time has passed, goes back to step 902 and continues from there. At step 908, a comparison is made with the high and low thresholds configured for the CPU and Memory SLAs. Next, at step 910, scale-up is generated if average CPU/Memory usage is greater than the high threshold and scale-down is generated if the average CPU/Memory usage is less than or equal to the low threshold. High and Low thresholds are configured by the data center administrator as part of the SLA Engine configuration. Next, the process continues to 904 and resumes from there.

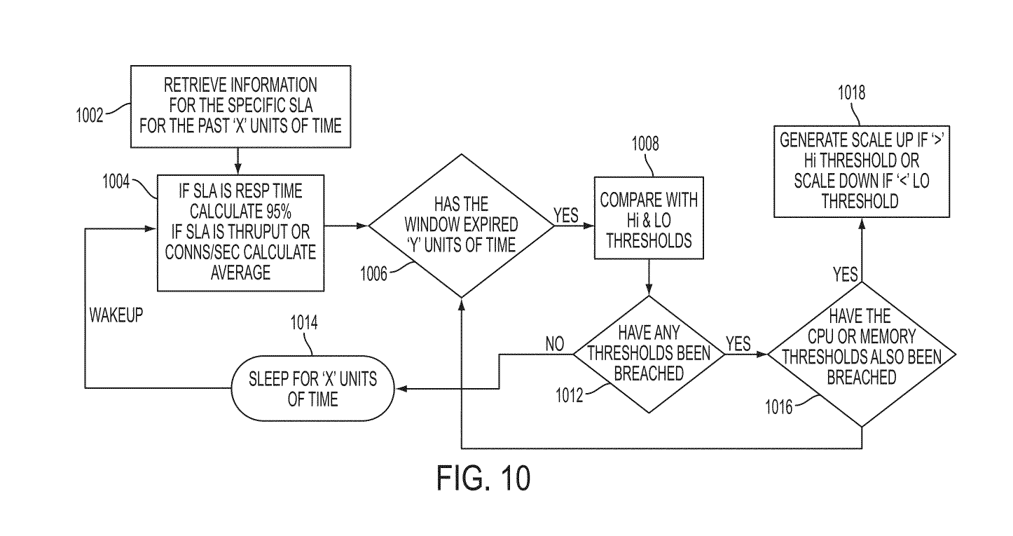

FIG. 10 shows a flow chart of the relevant steps performed for SLA analyzer for application-specific SLAs. Application-specific SLAs include but are not limited to response time, throughput, or connections/second.

In FIG. 10, at step 1002, information for the specific SLA is retrieved from the time series statistics database of the SLA Enginer for the past x units of time, as done in FIG. 9. Next, at step 1004, if the SLA is for response time, a 95% calculation of response time is made and if the SLA is for throughput or connections/second, an average is calculated. The process continues on to 1006 where a determination is made as to whether or not the window of time of ‘y’ units of time has expired, in other words, a predetermined period of time measured in units of ‘y’ has passed and if so, the process continues to step 1008, otherwise, the process continues to 1014 where it waits for a period of time defined by ‘x’ units.

At step 1008, the calculated 95% response time or average throughput/connections per second value is compared with high and low thresholds and at 1012, if it is determined that any of the thresholds (high and low) have been breached, the process moves onto 1016, otherwise, the process goes to 1014. At 1016, it is determined whether or not the CPU or memory thresholds also have been breached and if so, the process continues to step 1018, otherwise, the process goes to 1014. Once the ‘x’ units of time have been exhausted at 1014, the process resumes from step 1004, in other words, it wakes up and goes to step 1004.

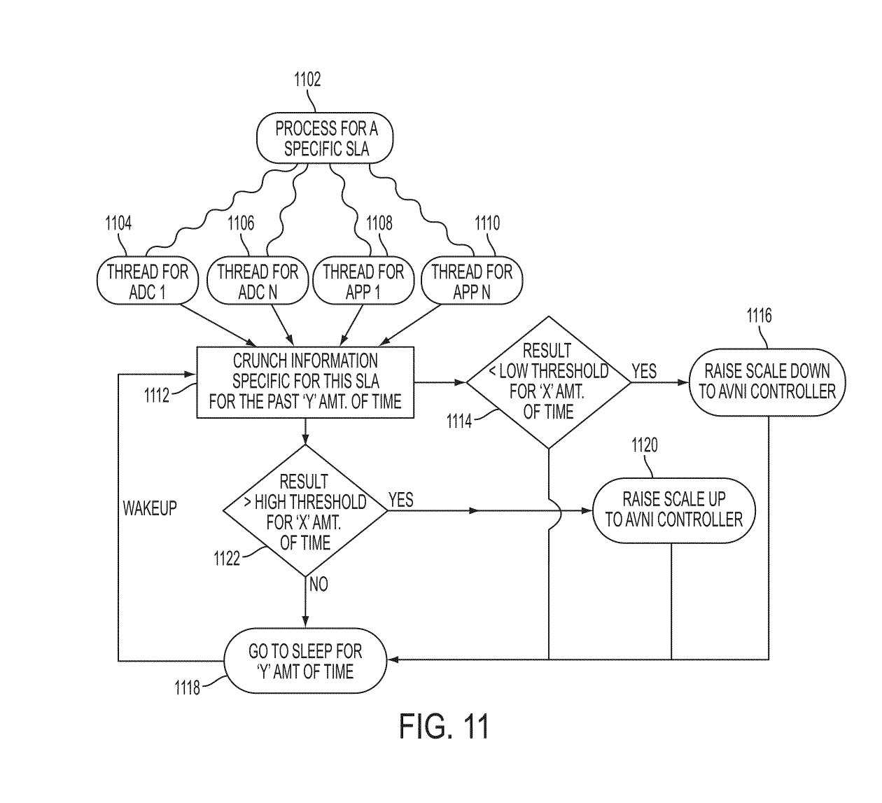

FIG. 11 shows a flow chart for the relevant steps performed for processing specific SLA. At 1102, the process begins. At 1104 and 1106, a separate thread is created for each ADC, for instance, at 1104, the thread for ADC 1 is created and at 1106, the thread for ADC m is created. Similarly, at 1108 and 1110, separate threads for application 1 and application n are created, respectively.

Next, at 1112, information specific for this particular SLA is crunched for a time period of ‘y’ units of time. Next, at 1122, if the result of step 1112 is greater than the high threshold for a period of time defined by ‘x’, the process continues to 1120, otherwise, the process continues to 1118. At 1118, the process effectively ends for a time period defined by ‘y’ units of time after which the process resumes starting from step 1112. At 1120, raising of the scale-up is performed to the controller 212 after which the process continues on to 1118.

At 1114, if the result of the step 1112 is less than the low threshold for an ‘x’ units of time, the process continues to 1116 where scale-down is raised to the controller 212.

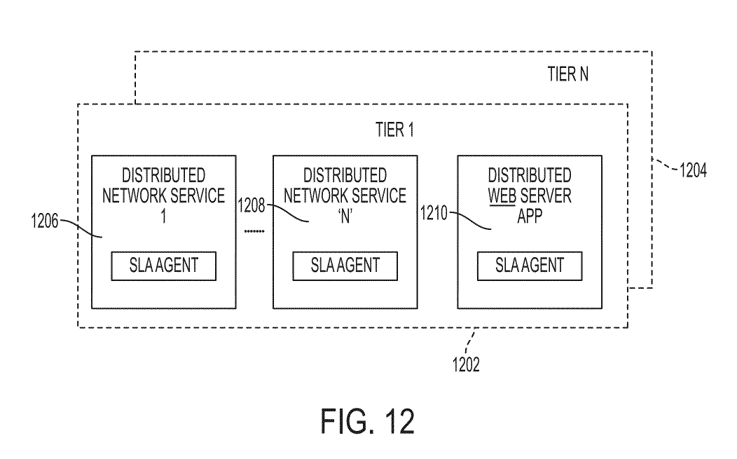

FIG. 12 shows a high-level block diagram of a data center using multiple tiers, in accordance with an embodiment of the invention. In this example, tiers 1202 (tier 1) through tier 1204 (tier n) are shown with ‘n’ being an integer. Tier 1202 is shown to include a distributed network service 1 1206 that includes a SLA agent. Another portion, or perhaps the remainder, of the distributed network service of which the service 1206 is a part is shown also included in tier 1202, as distributed network service n 1208, which also includes a SLA agent. Tier 1202 is further shown to include a distributed web server application 1210, as opposed to a network service such as in services 1206 and 1208. The application 1210 similarly includes a SLA agent. While now seen in FIG. 12, tier 1204 similarly might have distributed network services and web server applications. The part of the data center 100 shown in FIG. 12 serves merely as an example.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What is claimed is:

1. A multi-cloud fabric comprising:
a controller including a service level agreement (SLA) engine, the SLA agent being required to meet SLA,
wherein the SLA engine responsive to information from a plurality of SLA agents and in conjunction with the controller operable to aggregate the information from the plurality of SLA agents, the SLA agent further operable to automatically scale-up or scale-down network service, network application, or network servers to meet the SLA.

2. The multi-cloud fabric, as recited in claim 1, wherein SLA is based on resource metrics, power consumption metrics, application performance metrics, network metrics, application type, user requirements, location, cloud type, time of day, SLA feedback, or a combination thereof.

3. The multi-cloud fabric, as recited in claim 1, wherein SLA engine is operable to generate one or more SLA reports.

4. The multi-cloud fabric, as recited in claim 3, wherein the report is generated based on a plurality of conditions.

5. The multi-cloud fabric, as recited in claim 4, wherein the conditions including meeting SLA, not meeting SLA, or one or more SLA levels.

6. The multi-cloud fabric, as recited in claim 5, wherein SLA levels including application, tier, server, virtual memory, network service, or a combination thereof.

7. The multi-cloud fabric, as recited in claim 1, wherein the SLA engine is operable to predict and recommend.

8. The multi-cloud fabric, as recited in claim 7, wherein the SLA engine is operable to predict and recommend by learning from one tier and applying the learning to another tier.

9. The multi-cloud fabric, as recited in claim 8, wherein the SLA engine is operable to predict and recommend based on application comparison.

10. The multi-cloud fabric, as recited in claim 8, operable to automatically ramp-up based on the prediction and recommendation.

11. The application delivery fabric, as recited in claim 1, wherein the SLA engine is a machine-learning SLA engine.

12. A method of managing a service level agreement (SLA) of a data center comprising:
receiving information from a plurality of SLA agents;
aggregating the received information; and
automatically scaling-up or scaling-down network service, network application, or network servers of the data center to meet the SLA.
